(19) United States
(12) Patent Application Publication
(10) Pub. No.: US 2009/0327088 A1
(43) Pub. Date: Dec. 31, 2009

(54) System and Method for performing International Transactions

(75) Inventors: Devarajan Puthupparambil, Rolling Meadows, IL (US); J. Schneider, Grayslake, IL (US)

Correspondence Address: UTSTARCOM, INC., 3800 GOLF ROAD, SUITE 220, ROLLING MEADOWS, IL, 60008, US

(73) Assignee: UTStarcom, INC., Alameda, CA (US)

(21) Appl. No.: 12/146,670

(22) Filed: Jun. 26, 2008

(51) Int. Cl. G06Q 10/00; G06Q 20/00

(52) U.S. Cl. 705/21; 705/1; 705/35

(57) ABSTRACT

A transaction routing system that includes a communication gateway is provided. The communication gateway receives transaction data from at least one transaction terminal and determines whether to route the transaction data to an international host server or to a local host server. The decision is based on a capability of the communication gateway to route the transaction data to the international host server.

### BACKGROUND

The invention generally relates to Internet Protocol based transaction sessions, and more specifically, to a system and method for performing international transactions.

Currently, during an international transaction by a person at a foreign location, the transaction data is routed from the local Point-of-Sale (POS) terminals or the local merchant web servers to the destination host servers. Usually, the host servers are available locally. Therefore, the transactions are also conducted in the local currency.

The merchant banks and acquirers have settlement agreements that define the manner in which data is transferred and the interchange currency rates are applied in such an international transaction. However, such a process involves a lot of delay between the time the transaction is made and the time of settlement. In addition, routing of the international transaction generally involves intermediary banks and clearing houses, which in turn introduce more delay. This delay offers opportunities for fraud by eavesdroppers and other fraudulent parties. Moreover, due to the fluctuations in the currency rates, there are chances that both the user and the bank may be impacted either positively or negatively.

There is therefore a need for techniques to provide faster processing of international transactions.

### SUMMARY

According to one aspect of the present techniques, a transaction routing system is provided. The transaction routing system includes a communication gateway which receives transaction data from at least one transaction terminal and determines whether to route the transaction data to an international host server or to a local host server. The decision is based on a capability of the communication gateway to route the transaction data to the international host server.

According to another aspect of the present techniques, a method for transaction routing is provided. Transaction data, including a transaction amount, is received at a communication gateway during a transaction session. It is determined if the transaction data can be routed to an international host server. The transaction data is updated with the transaction amount in a currency of the user to generate a new transaction data and routed to the international host server in case the transaction data can be routed to the international host server.

### BRIEF DESCRIPTION OF THE DRAWINGS

These and other features, aspects, and advantages of the present invention will become better understood when the following detailed description is read with reference to the accompanying drawings in which like characters represent like parts throughout the drawings, wherein:

FIG. 1 is a schematic diagram of an exemplary IP-based transaction processing system for use during an international transaction, in accordance with aspects of the present techniques; and

FIG. 2 is a flow diagram representing the transaction routing of an international transaction in the IP-based transaction processing system of FIG. 1, in accordance with aspects of the present techniques.

### DETAILED DESCRIPTION OF EXEMPLARY EMBODIMENTS

In the following paragraphs, an approach for routing international transactions, over an Internet Protocol (IP) based communication network will be explained in detail. The architecture and the approach described hereinafter presents a technique for quickly and efficiently closing international transactions over the Internet. Such international transactions, initiated at an IP-based Point-of-Service (IP POS) transaction terminal, and involving currency conversions is performed at communication gateways which subsequently route the information to host servers. An IP POS transaction terminal, as used in this context, may be defined as a transaction terminal facilitating different types of electronic transactions, which may include, in one embodiment, a Point-of-Sale terminal that is commonly used to retail credit or debit transactions. The transactions performed over the IP POS terminals and the IP-based networks are processed securely via the use of various IP protocols, transaction protocols, and, security or authentication and authorization protocols. As will be appreciated by those of ordinary skill in the art, the technique is applicable to various systems that perform secure transactions over IP-based networks across international borders. Indeed, the exemplary uses and implementations described herein are merely provided as examples to facilitate understanding of the presently contemplated techniques. Therefore, the various aspects of the present technique will be explained, by way of examples only, with the aid of figures hereinafter.

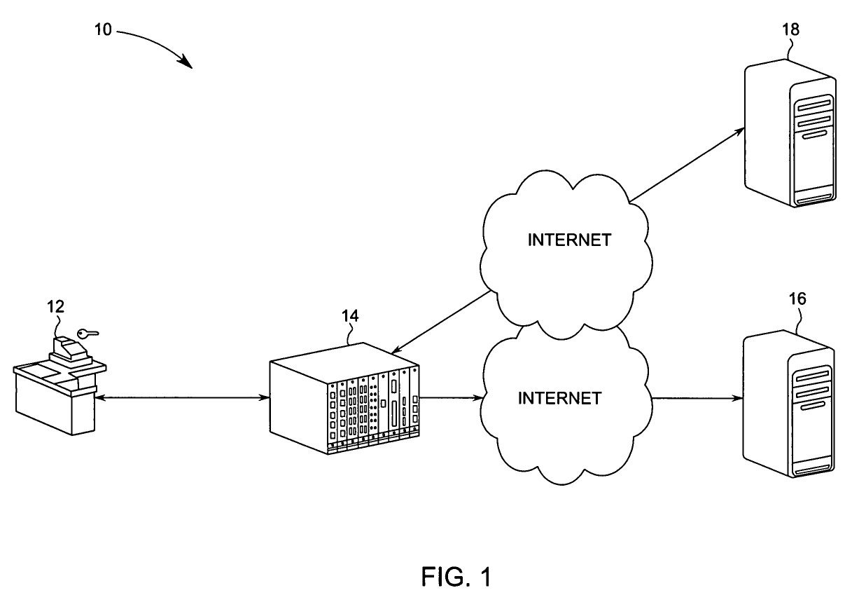

Referring generally to FIG. 1, the transaction processing and routing process will be described by reference to an exemplary IP-based transaction processing system designated generally by reference numeral 10. It should be appreciated however, that the transaction processing system 10 may find application in a range of settings and systems, and that its use in international transaction processing described herein is but one such application. As will be explained in detail, the transaction processing system 10 is employed in various kinds of applications ranging from simple POS transactions to more complex communications, such as for example, a secure access, a secure message exchange between two devices, and the like.

Although the techniques described herein are equally applicable to transactions performed locally, the following description focuses on international application of the transaction processing system 10 to facilitate better understanding. Therefore, the techniques are explained with respect to a transaction performed by a user at an overseas location, and, any reference to “foreign”, “local”, or “international” is generally with respect to the IP POS transaction terminal 12 at the overseas location, unless otherwise specified. The transaction processing system 10 therefore includes IP POS transaction terminals 12 deployed at various retail locations, communication gateways or transaction gateways 14 arranged across regions, and local host servers 16 positioned at specific locations, all devices located locally with respect to the IP POS transaction terminals. The transaction terminals 12 are communicatively coupled to communication gateways 14 through a secure public network, such as but not limited to a Secure Sockets Layer (SSL) network over the Internet or an Internet Protocol Security (IPSec) connection. Various such communication gateways 14 may be communicatively coupled to each other over a secure public network, such as the Internet, via secure protocol links like IPSec connections. Many communication gateways 14 are further communicatively linked to the local host servers 16 over a secure private network, such as via a simple socket connection like Transmission Control Protocol (TCP) socket connection, a Transmission Control Protocol/Internet Protocol (TCP/IP) network, or a non-secure connection.

Each of the transaction terminals 12, deployed at various establishments, such as shops, are capable of accepting or performing a financial transaction through a credit card, a debit card, or any such financial instrument as may be contemplated by one of ordinary skill in the art. Similarly, the transaction terminal 12 is also capable of handling other transactions, such as a secure access or a secure message exchange, that involve currency exchange. The various communication gateways 14 are preferably configured to convert an incoming communication that uses a certain transaction protocol into an aggregated outgoing communication that uses the host-compatible transaction protocol in Layer 7. Therefore, it serves to facilitate compatible communication exchanges between multiple end users (such as various IP POS transaction terminals 12) and, for example, an authorization host server 16.

The host servers 16 may similarly include a host socket connection, which links to the communication gateway 14 and facilitates provision of the abovementioned outgoing communication that is aggregated with respect to Layer 3. Those skilled in the art would recognize that a range of other IP protocols or socket connections may be utilized, such as but not limited to Network Time Protocol (NTP), User Datagram Protocol (UDP), Domain Name System (DNS), Lightweight Directory Access Protocol (LDAP), Routing Information Protocol (RIP) and its IP versions of RIP, RIPv1, RIPv2, and RIPng, Open Shortest Path First (OSPF), as presently known, or others hereafter developed. The transaction protocols supported by the communication gateway 14, in order to conduct a transaction, includes VISAI (EIS 1051), VISAII (EIS 1052), ISO 8583, Transport Protocol Data Unit (TPDU), Transparent protocol, and, various custom protocols as are known in the art to facilitate interaction between host servers 16 and transaction terminals 12.

In one embodiment of the invention, when the user transacts at an overseas merchant establishment having a transaction terminal 12 or at a merchant website with a web-server, the transaction data is received at the local communication gateway 14 through a secure public network, such as an SSL session. This transaction data includes information material to the current transaction and general information about the financial instrument employed, such as the transaction amount in local currency, the issuing bank information, the issuing bank host server, the service currency of the financial instrument, among other information. The communication gateway 14 determines if it is configured to route the transaction data to an international host server, such as an international issuing bank host server 18, or to a local authorization host server 16, or to both. Depending upon whether the transaction data is to be routed to either or both of the international issuing bank host server 18 and the local authorization host server 16, the communication gateway 14 transmits the data to the respective location.

It may be noted that the communication gateway 14 possesses the currency exchange rates which it may obtain on a daily basis, or, may retrieve from international exchange servers on the spot. The communication gateway 14 utilizes this interchange rate, along with commission rate, and other specific charges as may be defined by the merchant establishment and/or the clearing house to generate the amount to be charged to the user account in the foreign currency. In other words, the communication gateway 14 calculates the transaction amount in the currency of the user. Further, the communication gateway 14 generates an updated transaction authorization request appended with the transaction amount in the currency of the user. The communication gateway 14 forwards this updated transaction authorization request to the international issuing bank host server 18 over a secure public network, such as an SSL session over the Internet. The international issuing bank host server 18 transmits a transaction approved response to the local communication gateway 14.

The transaction data is transmitted to the local authorization host server 16 in case the communication gateway 14 is configured to route the transaction data to the local authorization host server 16. The transaction data may also be routed to the local authorization host server 16 even if the communication gateway 14 is configured to route the transaction data to the international issuing bank host server 18. This allows the local authorization host server 16 to maintain records of the executed transaction. Such records may then be used for reconciliation with the issuing bank or the international issuing bank host server 18. In this case, the local authorization host server 16 handles the entire transaction and authorizes the payment. Therefore, the local authorization host server 16 transmits a transaction approved response to the communication gateway 14. The communication gateway 14 then integrates any such response received from the local authorization host server 16 and/or the response from the international issuing bank host server 18 and presents the integrated response to the transaction terminal 12, and the transaction is then closed.

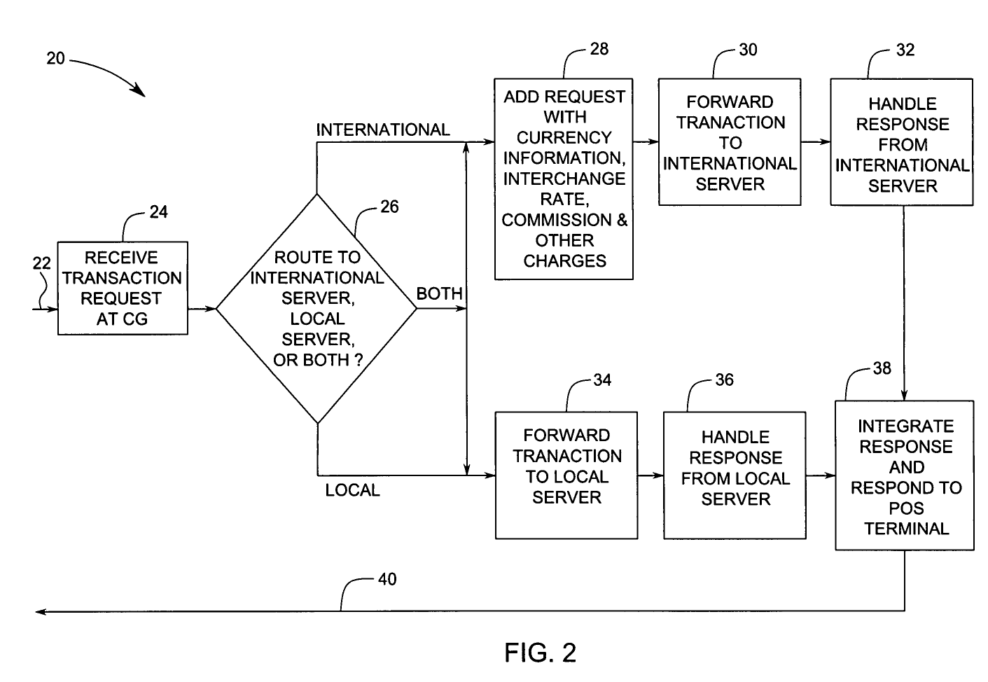

Turning now to FIG. 2, which is a flow diagram 20 representing the transaction routing of an international transaction in the IP-based transaction processing system of FIG. 1, the technique will be explained in further detail. The process 20 begins with a user initiating 22 an international transaction session at a merchant establishment or at a merchant server located at an overseas location. In the former case, the transaction request is received 24 by the communication gateway 14 from the local transaction terminal 12, while in the latter case, the local communication gateway 14 receives 24 the transaction request from the web-server. The local communication gateway 14 determines 26 if the communication gateway is configured to route the transaction data to either an international issuing bank host server 18 or a local authorization host server 16, or both. Depending upon whether the transaction data is to be routed to either or both the international issuing bank host server 18 and the local authorization host server 16, the communication gateway 14 transmits the data to the respective location. However, in certain embodiments, the communication gateway 14 may direct all international transactions to the international issuing bank host server 18. In still other embodiments, the communication gateway 14 may direct all international as well as local transactions to the local authorization host server 16 only. Again, depending upon the configuration of the communication gateway 14, in various other embodiments, it may be possible to direct all international transactions to both the local server 16 and the international server 18. This allows the local authorization host server 16 to maintain records of the executed transaction, which may then be used for reconciliation with the issuing bank or the international issuing bank host server 18.

If the communication gateway 14 is configured to route the transaction data to the international issuing bank host server 18 or if the transaction data is routed to the international issuing bank host server, the communication gateway updates 28 the transaction authorization request of the transaction terminal 12 with the amount to be charged to the user account in the foreign currency to generate a new transaction data or a new transaction authorization request. The communication gateway 14 calculates this new transaction data including the new amount with information such as the amount in local currency from the transaction, the currency interchange rate, commission rate, and other specific charges as may be determined by the merchant establishment and/or the clearing house. The new transaction authorization request is forwarded 30 by the communication gateway 14 to the international issuing bank host server 18. The international issuing bank host server 18 authorizes the transaction and responds with a transaction approved response. This response is handled 32 by the local communication gateway 14.

If the local communication gateway 14 is, however, configured to route the transaction to the local authorization host server 16 or if the transaction data is routed to the local authorization host server, the communication gateway transmits 34 the transaction data with the amount in local currency to the local authorization host server. When the transaction is approved, the local authorization host server 16 responds with a transaction approved response. This response from the local authorization host server 16 is handled 36 by the communication gateway 14, which finally integrates 38 the response it receives from the local authorization host server 16 and the international issuing bank host server 18 to generate 40 a response for the transaction terminal 12.

Therefore, the technique described hereinabove empowers the communication gateway 14 to decide if a certain international transaction is to be handled locally, or at the international issuing bank host server 18, or both. In either case, the communication gateway 14 accepts the transaction approved response from the respective server and responds to the transaction terminal in order to close the transaction.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

1. A transaction routing system, comprising:
a communication gateway configured to receive transaction data from at least one transaction terminal and determine whether to route the transaction data to an international host server or to a local host server based on a capability of the communication gateway to route the transaction data to the international host server.

2. The transaction routing system of claim 1, wherein the communication gateway is configured to receive the transaction data from a financial instrument through the at least one transaction terminal.

3. The transaction routing system of claim 1, wherein the at least one transaction terminal comprises a Point-of-Service transaction terminal.

4. The transaction routing system of claim 1, wherein the communication gateway is configured to determine an amount to be charged to a user account in a currency of the user.

5. The transaction routing system of claim 1, wherein the communication gateway is configured to determine an amount to be charged to a user account based on one or more of a transaction amount in local currency, an interchange rate, a commission rate, and specific charges defined by a merchant.

6. The transaction routing system of claim 1, wherein the communication gateway is configured to route the transaction data in a currency of the user to the international host server.

7. The transaction routing system of claim 1, wherein the communication gateway is configured to route the transaction data in a local currency to the local host server.

8. The transaction routing system of claim 1, wherein the communication gateway is configured to integrate a transaction approved response from the international host server and a transaction approved response from the local host server.

9. The transaction routing system of claim 1, wherein the communication gateway is configured to transmit a response to the at least one transaction terminal based on a transaction approved response from either the international host server or the local host server.

10. The transaction routing system of claim 9, wherein the at least one transaction terminal is configured to close the transaction based on the response to the at least one transaction terminal from the communication gateway.

11. The transaction routing system of claim 1, wherein the communication gateway is communicatively coupled to the international host server and the local host server via secure socket connections over a secure public network.

12. A method for transaction routing, the method comprising:
receiving transaction data, comprising a transaction amount, at a communication gateway during a transaction session; and
determining if the transaction data can be routed to an international host server; and
updating the transaction data with the transaction amount in a currency of the user to generate a new transaction data and routing the new transaction data to the international host server if transaction data can be routed to the international host server.

13. The method of claim 12, comprising:
routing the transaction data with the transaction amount in local currency to a local host server if the transaction data can not be routed to the international host server.

14. The method of claim 12, wherein receiving transaction data comprises receiving transaction data from an international financial instrument via at least one transaction terminal.

15. The method of claim 12, wherein receiving transaction data comprises receiving transaction data including the transaction amount in local currency.

16. The method of claim 12, wherein updating the transaction data comprises calculating the transaction amount in the currency of the user based on one or more of the transaction amount in local currency, an interchange rate, a commission rate, and specific charges defined by a merchant.

17. The method of claim 12, comprising:
receiving a transaction approved response, from at least on of the international host server and the local host server, at the communication gateway to generate a response for at least one transaction terminal.

18. The method of claim 17, comprising:
transmitting the response to the at least one transaction terminal; and
closing the transaction session based on the response to the at least one transaction terminal.

19. A method for international transaction routing, comprising:
initiating an international transaction session at a transaction terminal and routing transaction data to a communication gateway;
determining whether the communication gateway is configured to route transaction data to an international host server; and
routing an updated transaction data to the international host server if the communication gateway is configured to route transaction data to the international host server, or, routing the transaction data to a local host server if the communication gateway is not configured to route transaction data to the international host server.

20. The method of claim 19, comprising:
receiving a transaction approved response, from either the international host server or the local host server, at the communication gateway;
generating a response for the transaction terminal based on the transaction approved response; and
transmitting the response to the transaction terminal for closing the international transaction session.

21. The method of claim 19, wherein routing the updated transaction data comprises:
calculating a transaction amount in the currency of the user based on one or more of the transaction amount in local currency, an interchange rate, a commission rate, and specific charges defined by a merchant; and
generating the updated transaction data based on the transaction amount.
